(19) United States
(12) Patent Application Publication
(10) Pub. No.: US 2020/0221056 A1
(43) Pub. Date: Jul. 9, 2020

(54) SYSTEMS AND METHODS FOR PROCESSING AND DISPLAYING IMAGE DATA BASED ON ATTITUDE INFORMATION

(71) Applicant: SZ DJI TECHNOLOGY CO., LTD., Shenzhen (CN)

(72) Inventors: Zisheng CAO, Shenzhen (CN); Linchao BAO, Shenzhen (CN); Pan HU, Shenzhen (CN); Mingyu WANG, Shenzhen (CN)

(21) Appl. No.: 16/813,189

(22) Filed: Mar. 9, 2020

Related U.S. Application Data
(63) Continuation of application No. PCT/CN2017/104508, filed on Sep. 29, 2017.

(51) Int. Cl. H04N 7/18; H04N 5/225; H04N 5/445

(52) U.S. Cl. CPC H04N 7/183; H04N 5/445; H04N 5/2253

(57) ABSTRACT

A method for processing image data of an environment includes obtaining a plurality of images captured using an imaging device and attitude information of the imaging device corresponding to the plurality of images, and associating the plurality of images with the corresponding attitude information of the imaging device.

### CROSS-REFERENCE TO RELATED APPLICATION

This application is a continuation of International Application No. PCT/CN2017/104508, filed Sep. 29, 2017, the entire content of which is incorporated herein by reference.

### BACKGROUND

Aerial vehicles, such as unmanned aerial vehicles (UAVs), have been developed for a wide range of applications including surveillance, search and rescue operations, exploration, and other fields. Such UAVs can carry onboard cameras to capture still images and video images of environment.

A UAV can also carry onboard attitude sensor, such as an IMU (inertial measurement unit), to obtain attitude information of the UAV. The attitude information can be used to track and predict the UAV's position. An attitude sensor can also be provided to the camera to track an attitude of the camera during image capturing.

### SUMMARY

Systems and methods are provided for processing and displaying images of an environment based on attitude information of an imaging device (e.g., a camera) and attitude information of a displaying terminal (e.g., a smart phone). The attitude information of the imaging device at a timing of capturing images is measured and associated with the images. The images can be selected and displayed on the displaying terminal based on a corresponding attitude information of the displaying terminal. In some embodiments, an image which is captured with a first attitude can be selected to be displayed when the displaying terminal is at a second attitude that substantially corresponds to the first attitude. The captured image can be a static image or a moving image such as a video. Various embodiments provided herein enable a virtual reality experience of the user. The user can change an attitude of the displaying terminal by simply tilting it and view images having different FOV (Field of View) of the captured environment.

An aspect of the disclosure may provide a method for processing image data of an environment. The method can comprise obtaining (1) a plurality of images captured using an imaging device, and (2) attitude information of the imaging device corresponding to the plurality of images; and associating the plurality of images with the corresponding attitude information of the imaging device.

Aspects of the disclosure may also provide a system for processing image data of an environment. The system can comprise an imaging device configured to capture a plurality of images; an inertial sensor configured to collect attitude information of the imaging device corresponding to the plurality of images; and one or more processors that are individually or collectively configured to associate the plurality of images with the corresponding attitude information of the imaging device.

Aspects of the disclosure may also provide an apparatus for processing image data of an environment. The apparatus can comprise one or more processors that are individually or collectively configured to obtain (1) a plurality of images captured using an imaging device and (2) attitude information of the imaging device corresponding to the plurality of images; and associate the plurality of images with the corresponding attitude information of the imaging.

Aspects of the disclosure may also provide a non-transitory computer readable medium comprising machine executable code that, upon execution by one or more computer processors, implements a method for processing image data of an environment. The non-transitory computer readable medium can comprise program instructions for obtaining (1) a plurality of images captured using an imaging device and (2) attitude information of the imaging device corresponding to the plurality of images; and program instructions for associating the plurality of images with the corresponding attitude information of the imaging device.

Aspects of the disclosure may also provide a movable object. The movable object can comprise one or more propulsion units that effect a movement of the movable object; and the system for processing image data of an environment of aspects of the disclosure.

Aspects of the disclosure may also provide a method for displaying image data of an environment on a displaying terminal. The method can comprise obtaining attitude information of the terminal; selecting, from among a plurality of images, one or more images to be displayed on the terminal based on the attitude information of the terminal, wherein said plurality of images are captured by an imaging device and associated with corresponding attitude information of the imaging device; and displaying, on the terminal, the selected one or more images.

Aspects of the disclosure may also provide a displaying terminal of displaying image data of an environment. The terminal can comprise one or more processors that are individually or collectively configured to: obtain attitude information of the terminal; select, from among a plurality of images, one or more images to be displayed on the terminal based on attitude information of the terminal, wherein said plurality of images are captured by an imaging device and associated with corresponding attitude information of the imaging device; and display, on the apparatus, the selected one or more images.

Aspects of the disclosure may also provide a non-transitory computer readable medium comprising machine executable code that, upon execution by one or more computer processors, implements a method for displaying image data of an environment. The non-transitory computer readable medium can comprise program instructions for obtaining attitude information of a displaying terminal; program instructions for selecting, from among a plurality of images, one or more images to be displayed on the terminal based on attitude information of the terminal; and program instructions for displaying, on the terminal, the selected one or more images.

Aspects of the disclosure may also provide a method for processing image data of an environment. The method can comprise receiving a target viewing orientation; selecting, from among a plurality of images, one or more images to be displayed on the terminal based on the attitude information of the terminal, wherein said plurality of images are captured by an imaging device and associated with corresponding attitude information of the imaging device; and displaying, on a terminal, the selected one or more images.

Aspects of the disclosure may also provide a terminal of displaying image data of an environment. The apparatus can comprise an interface of receiving a target viewing orientation; one or more processors that are individually or collectively configured to: selecting, from among a plurality of images, one or more images to be displayed on the terminal, wherein the one or more images are selected based on the attitude information of the terminal, wherein said plurality of images are captured by an imaging device and associated with corresponding attitude information of the imaging device; and displaying, on the terminal, the selected one or more images.

Aspects of the disclosure may also provide a non-transitory computer readable medium comprising machine executable code that, upon execution by one or more computer processors, implements a method for displaying image data of an environment. The non-transitory computer readable medium can comprise program instructions for receiving a target viewing orientation; program instructions for selecting, from among a plurality of images, one or more images to be displayed on the terminal based on the attitude information of the terminal, wherein said plurality of images are captured by an imaging device and associated with corresponding attitude information of the imaging device; and program instructions for displaying, on a terminal, the selected one or more images.

It shall be understood that different aspects of the disclosure can be appreciated individually, collectively, or in combination with each other. Various aspects of the disclosure described herein may be applied to any of the particular applications set forth below or for any other types of stationary or movable objects. Any description herein of aerial vehicles, such as unmanned aerial vehicles, may apply to and be used for any movable object, such as any vehicle. Additionally, the systems, devices, and methods disclosed herein in the context of aerial motion (e.g., flight) may also be applied in the context of other types of motion, such as movement on the ground or on water, underwater motion, or motion in space.

Other objects and features of the present disclosure will become apparent by a review of the specification, claims, and appended figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a UAV capturing images of an environment at various orientations, in accordance with an embodiment of the disclosure.

FIG. 2 shows an exemplary configuration of storing images captured by an imaging device and attitude information of the imaging device corresponding to the images, in accordance with an embodiment of the disclosure.

FIG. 3 shows an exemplary configuration of storing images captured by an imaging device and attitude information of the imaging device corresponding to the images, in accordance with another embodiment of the disclosure.

FIG. 4 shows a user holding a displaying terminal and viewing images captured by a camera under various orientations, in accordance with an embodiment of the disclosure.

FIG. 5 shows a user holding a displaying terminal and viewing images captured by a camera under various orientations, in accordance with another embodiment of the disclosure.

FIG. 6 shows a user manipulating an input device and viewing images captured by a camera under various orientations on a displaying terminal, in accordance with an embodiment of the disclosure.

FIG. 7 is a flow chart illustrating a method of processing images of an environment based on attitude of displaying terminal, in accordance with an embodiment of the disclosure.

FIG. 8 is a flow chart illustrating a method of displaying image data of an environment on a displaying terminal based on attitude of the terminal, in accordance with an embodiment of the disclosure.

FIG. 9 is a flow chart illustrating a method of processing images of an environment based on attitude of imaging device and/or user's target viewing orientation, in accordance with an embodiment of the disclosure.

FIG. 10 illustrates a movable object including a carrier and a payload, in accordance with embodiments of the present disclosure.

### DETAILED DESCRIPTION

A need exists for providing an improved experience of virtual reality when displaying a plurality of images of an environment. The plurality of images can be captured at various orientations by a camera carried by an unmanned aerial vehicle (UAV). For instance, the UAV may fly around a tall structure such as a skyscraper. The UAV can capture images of the skyscraper at various orientations by flying around it in the three-dimensional space. The images may be captured from various perspectives. For instance, while the UAV is flying around, the UAV may capture images of an object, such as the skyscraper, while at different positions relative to the skyscraper. The UAV may capture images at a single orientation from each perspective, or different orientations. Image capture from a UAV can allow for the various orientations and perspectives of images, which may enrich a virtual reality experience of the user, which are not available from a ground-level image collection. In this example, the user can view images of the skyscraper from an angle of “looking down from above”. By collecting images during flight, the user has access to many perspectives in three-dimensional space that may otherwise not be readily accessed.

The attitude information of the camera may be obtained by an attitude sensor such as inertial measurement unit (IMU) at a timing each of the plurality of images is captured. The captured images can be associated with the corresponding attitude information. This may advantageously allow the attitude of the camera for each image to be known, which will aid in the creation of the virtual reality experience. Optionally, relative position of the camera may be known.

A user can view the images on a displaying terminal, such as a smart phone or a wearable display device. The images may be selected for display based on an attitude of the displaying terminal. For instance, the image captured at an attitude corresponding to the current attitude of the displaying terminal is displayed. The user can change the attitude of the displaying terminal, such as by tilting the terminal, and view different images of the environment under a first person view (FPV). The images can be moving images such as a video. Using the tile of the display terminal to control the images displayed may advantageously provide a realistic virtual reality experience to a user. For instance, when the attitude of the terminal matches or is related to the attitude of the camera, the control of the terminal to view a desired field of view may be intuitive. For instance, if the user wants to look to the right within the virtual reality space, the user merely needs to turn the terminal rightward.

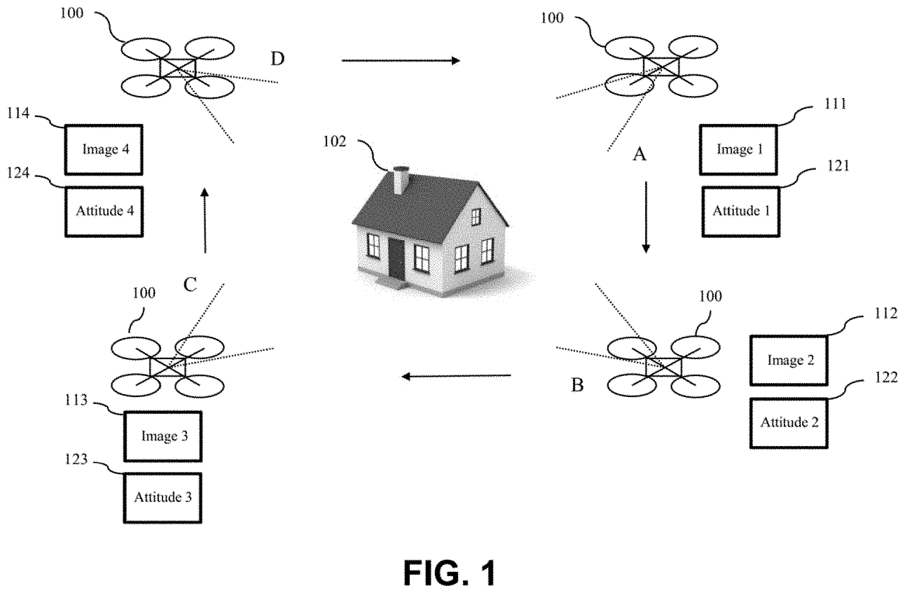

FIG. 1 shows a UAV 100 capturing images of an environment at various orientations, in accordance with an embodiment of the disclosure. The UAV 100 can carry an imaging device such as a camera. The camera is capable of capturing images of an environment. The images captured by the camera can be static images or moving images. In some instances, the UAV can perform a flight around the object 102 and capture a plurality of images of the object at different orientations. The corresponding attitude information of the imaging device can also be obtained while capturing the images.

Any description herein of a UAV may apply to any type of aerial vehicle, and vice versa. The aerial vehicle may or may not be unmanned. Similarly, any description herein of a UAV may apply to any type of movable object, and vice versa. A movable object may be a vehicle capable of self-propelled movement. The vehicle may have one or more propulsion units that may be capable of permitting the vehicle to move within an environment. A movable object may be capable of traversing on land or underground, on or in the water, within the air, within space, or any combination thereof. The movable object may be an aerial vehicle (e.g., airplanes, rotor-craft, lighter-than air vehicles), land-based vehicle (e.g., cars, trucks, buses, trains, rovers, subways), water-based vehicles (e.g., boats, ships, submarines), or space-based vehicles (e.g., satellites, shuttles, rockets). The movable object may be manned or unmanned.

The imaging device can capture images of an environment at various orientations. In some instances, the imaging device may capture images at different orientations by a movement of the UAV relative to the environment. For instance, the UAV carrying the imaging device can fly around an object while the imaging device is substantially stationery with respect to the UAV, thus the imaging device can capture images of the object at different attitude. The imaging device may remain at the same orientation relative to the UAV while the UAV alters its orientation relative to an inertial reference frame, such as the environment. Thus, the orientation of the imaging device relative to the environment may be directly controlled by the orientation of the UAV relative to the environment. The UAV's flight can be a combination of a translational movement and a rotational movement along/about one, two or three axes. The axes can be orthogonal or not. The axes may include a yaw, pitch, and/or roll axes.

Alternatively or additionally, the imaging device can capture images of an environment at various orientations by a movement of the imaging device relative to the UAV. For instance, the imaging device may rotate about one or more, two or more, or three or more axes relative to the UAV. For instance, the imaging device can move relative to UAV and capture image of an object within the environment while the UAV does not change an attitude during the flight, thus the imaging device can also capture images of the object at different attitude. For instance, the UAV may be hovering, or traveling translationally while the imaging device may capture images at various orientations relative to the environment. In another example, the UAV may be changing attitude relative to the environment while the imaging device is changing attitude relative to the UAV.

The imaging device can be coupled to the UAV via a carrier, such as a gimbal. The carrier may permit the imaging device to move relative to the UAV. For instance, the carrier may permit the imaging device to rotate around one, two, three, or more axes. For instance, the imaging device may move about a roll, yaw, and/or pitch axes. Alternatively or additionally, the carrier may permit the imaging device to move linearly along one, two, three, or more axes. The axes for the rotational or translational movement may or may not be orthogonal to each other. The imaging device can be at various orientations while capturing images during a flight of the UAV, by a combination of a movement of the UAV relative to the environment and a movement of the imaging device relative to the UAV. An attitude of the imaging device may be changed if any one of a roll orientation, a pitch orientation and a yaw orientation is changed.

An attitude of the imaging device may be determined. The attitude of the imaging device may be determined relative to an inertial reference frame, such as the environment. The attitude of the imaging device may be determined relative to a direction of gravity. In some embodiments, the attitude of the imaging device may be directly measured relative to the environment. In other examples, the attitude of the imaging device relative to the environment may be determined based on an attitude of the imaging device relative to the UAV and/or the attitude of the UAV relative to the environment. For instance, the attitude of the imaging device relative to the UAV may be known or measured. The attitude of the UAV relative to the environment may be known and/or measured. The attitude of the imaging device relative to the environment may be the attitude of the UAV relative to the environment added to the attitude of the imaging device relative to the UAV.

The attitude information of the imaging device can be measured by an attitude sensor provided with the imaging device. In some embodiments, an attitude sensor, such as an IMU, can be provided to the imaging device. The attitude sensor can be fixed to a housing of the imaging device, and the attitude information as measured by the attitude sensor is the attitude of the imaging device. Alternatively, the attitude information of the imaging device can be obtained from an attitude sensor provided with the UAV if the imaging device is coupled to the UAV or connected with the UAV such that the imaging device remains substantially stationary relative to the UAV. In this case, the attitude information as measured by the attitude sensor can be the attitude of the UAV and the imaging device.

Alternatively, the attitude information of the imaging device can be obtained from an attitude sensor provided with the UAV and the attitude information of a carrier, if the imaging device is coupled to the UAV via the carrier. The carrier can be a gimbal. A coupling between the imaging device and the UAV via the gimbal may permit movement of the imaging device relative to the UAV. The movement of the imaging device relative to the UAV may be translational (e.g., vertical, horizontal) and/or rotational (e.g., about a pitch, yaw, and/or roll axis). One or more sensors may detect the movement of the imaging device relative to the UAV. The movement of the imaging device relative to the UAV can also be obtained from the operation status of motors of the gimbal. The attitude information of the imaging device can be calculated from the attitude of the UAV, which is measured by the attitude sensor provided with the UAV, and the relative attitude of the imaging device relative to the UAV.

One or more sensors may be used to measure the attitude of an imaging device, component of a carrier (e.g., gimbal or frame component of a carrier), and/or UAV. The sensors may measure any of these attitudes relative to an environment, or relative to one another. Data from a single sensor be used, or multiple sensors may be combined in, in determining the attitude of the imaging device. The same type of sensor or different types of sensors may be used in determining the attitude of the imaging device.

The UAV can perform an aerial flight of any type of flight trajectory while capturing images of the environment. The flight trajectory can be a full circle, a half circle, an ellipse, a polygon, a straight line, a curve, or an irregular curve. The flight trajectory may be a flight path taken by the UAV during flight. The flight path may be planned or may be semi-planned. The flight path may be adjusted during flight.

The flight trajectory can be selected from preset options provided by the flight controller. For instance, the flight trajectory can be selected by a user from a number of preset options through a menu when planning an aerial flight. The preset options may include one or more predetermined shapes to the flight path. The shapes may include three dimensional, two dimensional, or one dimensional flight paths. For example, one preset option may have the UAV fly in an ascending spiral around an object while another preset option may have the UAV fly in a grid pattern within a vertical or horizontal plane. Other examples may include, but are not limited to, an elliptical path, a circular path, or any other type of polygonal path where the altitude may remain the same during flight or may vary during flight (e.g., tilted shape); or a straight or curved line that the UAV may traverse both forwards and backwards. The preset options may have fixed dimensions, or a user may be able to alter dimensions. For instance, after a user selects a flight path shape, the user may be able to adjust a dimension of the flight path, or vice versa. For example, if a user selects an ascending spiral pattern, the user may determine a location of the center of the spiral, a radius of the spiral, and/or how tight the spiral is (e.g., how quickly the UAV may ascend relative to how quickly it moves laterally). Thus, a user may select a preset option from a plurality of preset options and may optionally be able to adjust one or more parameters of the selected preset option.

Alternatively, the flight trajectory can be input and/or designed by the user. For instance, the user can select waypoints of a flight path. A customized flight trajectory may be generated that may allow the flight path to intersect the waypoints. The waypoints may be selected in any manner. For example, the waypoints may be selected on a map by allowing a user to tap on a terminal (e.g., a remote controller), so as to create a customized flight trajectory when planning an aerial flight. The user may tap a location on a map to create the waypoint. The user may be directly touching the map via a touchscreen, or may use a mouse, joystick, or any other type of user interaction device. The user may optionally enter coordinates that denote the location of the waypoints. The waypoints may be selected in two-dimensions or three-dimensions. For instance, a coordinate of a waypoint may include an altitude of the waypoint, in addition to a longitude and latitude. In another example, the user may tap a two-dimensional coordinate on a map and manually enter an altitude of the waypoint. In another example, the map may be a three-dimensional map, or a user may be able to access an altitude view that may allow a user to select an altitude of the waypoint.

Alternatively or additionally, the user can manually control the flight of UAV during the image capturing. For instance, the user may use a remote terminal to directly control the flight of the UAV in real-time. The user may control the flight of the UAV without having a preset plan or parameters.

In some embodiments, a user may enter one or more parameters for a flight trajectory and one or more processors may be configured to generate a flight trajectory in accordance with the one or more parameters. Examples of flight parameters may include, but are not limited to, boundaries of a region to be imaged (e.g., lateral and/or height), identification of one or more targets or objects to be imaged, desired density of image capture (e.g., how many different perspectives within an area or volume at which to capture images), energy usage, timing information (e.g., length of flight), communication requirements (e.g., staying within Wi-Fi zones, etc.).

The type of flight trajectory can be determined by considering features and/or parameters of the environment to be imaged. For instance, a circular trajectory can used to capture images of a site such as a building, to obtain details of the site at various angles. For another instance, a straight line trajectory or a curve trajectory can be used to capture a scene such as a river or beach. Known geographic or topologic data can be incorporated in generating the flight trajectory. For instance, geographic or topologic data on a terrain of a national park can be received from a government agency before planning the flight path. The type of flight trajectory can be additionally determined by considering an expected coverage of view point. For instance, if the user wishes to have a 360 degree aerial panorama of an object, then a circular flight around the object can be determined and performed, and if the user has interest of only selected side of the object, then a straight or a U-shaped flight can be employed.

In the exemplary example of FIG. 1, the UAV may take a circular flight around the object to be captured. The UAV may travel 360 degrees or more around the object. The UAV may travel 360 degrees or more laterally around the object. The object can be a building, landmark, structure, or natural feature. The circular flight may be beneficial in capturing images of the object from various directions, such that the user can observe the object at various angles. The UAV can fly around the object at least one full circle in order to create a virtual reality experience of the object to the user such that the user can view the object from arbitrary angle. For instance, the UAV may start the flight at waypoint A, at which the UAV captures an image 111 of the object. Then the UAV may sequentially reach waypoint B, C and D, capture images 112, 113 and 114 of the object respectively, and return to waypoint A. Any descriptions herein of waypoints may refer to locations at which images are captured. The waypoints may form perspectives from which images are captured. These waypoints may be the same or different from waypoints that a user may optionally use to define a flight trajectory. In some instances, a user may use a first set of points to define a flight trajectory and/or indicate a second set of points (which may or may not share one or more of the same points as the first set of points) that may indicate locations at which images are to be captured. In some instances, images are captured continuously while the UAV traverses a flight path. Alternatively, the images may be captured at discrete locations along the flight paths. The imaging device may be changing or maintaining orientation while traversing the flight path. In some instances, the imaging device may be changing or maintaining orientation at discrete locations along the flight path to obtain desired images of various attitudes.

The attitude information 121, 122, 123 and 124 of the imaging device, at the timing of capturing the respective images, can also be obtained. The attitude information of the imaging device can be obtained from an attitude sensor, as previously described. In some instances, the attitude sensor may be provided with the imaging device, or from an attitude sensor provided with the UAV, or from an attitude sensor provided with the UAV and attitude information of a carrier, as discussed herein above.

Optionally, the location of the imaging device at each of the waypoints may be known or obtained. For instance, the location of the imaging device within an environment (e.g., coordinates) may be known. The location of the imaging device relative to an object being imaged may be known or calculated. The location may include a distance and/or direction of the imaging device relative to the object.

Multiple images can be captured at each or any of the waypoints with difference orientations. For instance, the imaging device can capture multiple images of the environment at various orientations at each waypoint of the flight path. In some instances, the imaging device can capture images of the environment at various orientations at a predetermined time interval (e.g., every 1 second, 2 seconds, 3 seconds, 5 seconds, 10 seconds, 15 seconds, 20 seconds, 30 seconds, 40 seconds, or 60 seconds). Optionally, the imaging device can capture images of the environment at various orientations if a change in an attitude thereof reaches a predetermined value. For example, the imaging device can capture images of the environment at various orientations if a change in an attitude thereof reaches 5 degrees, 10 degrees, 15 degrees, 20 degrees, 25 degrees, 30 degrees, 35 degrees, 40 degrees, 50 degrees, 60 degrees, 70 degrees, 80 degrees, 90 degrees, 120 degrees, 150 degrees or 180 degrees. In some embodiments, the multiple images at a waypoint can be captured by one camera onboard the UAV. For instance, at a waypoint, the UAV can change an attitude thereof such that the camera onboard the UAV can capture images at various orientations. For another instance, at a waypoint, the carrier (e.g., a gimbal to which the camera is coupled) can change an attitude thereof while the UAV can keep substantially stationery. Alternatively, the multiple images at a waypoint can be captured by a plurality of cameras onboard the UAV. The plurality of cameras can be disposed directing at different orientation, such that the cameras can capture images of environment at different directions. Alternatively, the multiple images at a waypoint can be captured by a spherical camera on which a plurality of cameras are arranged directing at different orientation. In some embodiments, images may be captured at various orientations (e.g., from a single camera or multiple cameras), that may allow the field of views of the various orientations to be adjacent to one another or overlap. This may advantageously permit a rich virtual reality experience without significant jumps or gaps in the images being viewed. The images may be captured with sufficient density to allow a relatively smooth and realistic viewing experience as the user adjusts the attitude of the image viewed.

Alternatively or additionally, the UAV can fly around the object a plurality of circles at various orientations, such that images of the object can be captured with more details. In some instances, the plurality of circular flight can be at substantially the same height. For instance, the imaging device can capture images of a skyscraper at a certain pitch angle relative to the ground in one circular flight, and change the pitch angle relative to the ground in another circular flight. In this manner, images of the skyscraper at various pitch angles can be captured at a certain height. Optionally, the plurality of circular flights can be performed at different heights. For instance, the UAV can perform a circular flight around a skyscraper with a pitch in height (e.g., a pitch of 2 m, 5 m, 10 m or 20 m). For another instance, the UAV can perform an upward spiral flight around the skyscraper with a pitch in height. During each circular flight, images can be captured at various orientations, such that a great more information of the skyscraper can be obtained to create an enhanced virtual reality experience to the user. The UAV can be beneficial in creating a 3D virtual reality experience to the user, particularly in a case the object to be imaged is tall in height. For instance, the UAV can capture far more details in creating a virtual reality of a skyscraper than simply collecting images on ground.

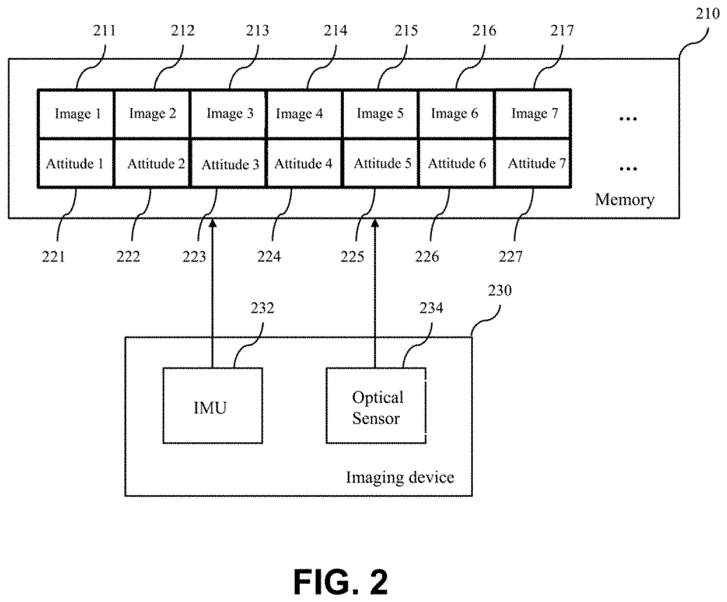

FIG. 2 shows an exemplary configuration of storing images captured by an imaging device and attitude information of the imaging device corresponding to the images, in accordance with an embodiment of the disclosure. The images 211-217 of environment, which are captured by an imaging device 230, can be stored together with the corresponding attitude information 221-227 of the imaging device in a memory 210. The association of the images and the corresponding attitude information can be performed by one or more processors, such as a programmable processor (e.g., a central processing unit (CPU)).

The imaging device 230 can be a camera carried by a movable object such as a UAV. Any description herein of a camera may apply to any type of image device, and vice versa. Any number of cameras may be provided. For instance, there may be 1 or more, 2 or more, 3 or more, 4 or more, 5 or more cameras carried by the UAV. In case a plurality of cameras are provided, the plurality of cameras can be disposed at different orientation such that the cameras can capture images of environment at different directions. The cameras can have same or different fields of view (FOV). For instance, three cameras each having a FOV of 120 degree can be provided to the UAV at a same plane such that a total 360 degree of view can be captured. The plurality of cameras can be provided in a spherical form, such that images of environment can be captured at various FOVs. The images of various FOVs can be stitched to generate a panoramic view of the environment. The images of the various FOVs can be stitched to obtain a complete 360 view laterally, and/or vertically.

The imaging device can be coupled to the UAV via a carrier such as a gimbal to provide stability in up to three dimensions. The imaging device can comprise an optical lens (not shown) and an image sensor 234. The optical lens is capable of directing light onto the image sensor. The image sensor can be any type capable of generating electrical signals in response to wavelengths of light. The optical lens can be stationery (e.g., a prime lens camera) or movable (e.g., a zoom camera). A zoom camera can be an optical zoom type or a digital zoom type lens. An optical zoom may enlarge an image with the aid of a set of optical lenses. The image sensor can be a charge-coupled device (CCD) sensor or a complementary metal-oxide-semiconductor (CMOS) sensor. The resultant electrical signals can be processed to produce image data. The image data generated by the imaging device can include one or more images, which may be static images (e.g., photographs), moving images (e.g., video), or suitable combinations thereof. The image data can be polychromatic (e.g., RGB, CMYK, HSV) or monochromatic (e.g., grayscale, black-and-white, sepia). The imaging device may capture images at a high enough frequency to provide video-rate capturing. Images may be captured at a rate of at least 10 Hz, 20 Hz, 30 Hz, 40 Hz, 50 Hz, 60 Hz, 70 Hz, 80 Hz, 90 Hz, 100 Hz, 120 Hz, 150 Hz, 200 Hz, 250 Hz, or 300 Hz. An image processor may be provided to receive image data from the imaging device and generate data to be displayed. The image processor can be provided onboard or off-board the UAV. For instance, the image processor can perform a processing to the captured images of a plurality of cameras and stitch the images to generate a panoramic view of the environment.

An attitude sensor can be provided to the imaging device to measure an attitude of the imaging device. The attitude sensor can include any suitable number and combination of inertial sensors, such as at least one, two, three, or more accelerometers, and/or at least one, two, three, or more gyroscopes. Examples of inertial sensors may include, but are not limited to, accelerometers, gyroscopes, gravity-detecting sensors, magnetometers, or any other sensors. Optionally, the attitude sensor can includes at least one, two, three, or more inertial measurement units (IMU), which each includes any number or combination of integrated accelerometers, gyroscopes, or any other type of inertial sensors. In some embodiments, one-axis, two-axis, or three-axis accelerometers may be provided. Optionally, one-axis, two-axis, or three-axis gyroscopes may be provided. Any number or combination of inertial sensors may be provided to detect an attitude of the imaging device about or along a single axis, about or along two axes, or about or along three axes. In the exemplary configuration of FIG. 2, an IMU 232 is provided as the attitude sensor to measure the attitude information of the imaging device while the imaging device captures images. The IMU can be provided at the imaging device. For instance, the IMU can be fixed to a housing of the imaging device.

The one or more sensors may measure an attitude of the imaging device relative to an inertial reference frame (e.g., environment). The one or more sensors may measure the attitude of an imaging device relative to another object, such as the UAV or a carrier of the UAV. The attitude information of the imaging device may be obtained based on measurements from the one or more sensors.

The attitude information of the imaging device can include at least one attitude of the imaging device relative to a reference frame (e.g., the surrounding environment). The measured attitude information of the imaging device can include the attitude of the imaging device with respect to three axes. For instance, the attitude information of the imaging device includes a pitch angle, a yaw angle, and/or a roll angle of the imaging device relative to the surrounding environment at a timing a corresponding image of the environment is captured. Alternatively or additionally, the attitude information of the imaging device can include an acceleration of the imaging device with respect to three axes of the surrounding environment at a timing a corresponding image of the environment is captured. For example, the acceleration of the imaging device can be acceleration of the imaging device with respect to a X-axis, a Y-axis and a Z-axis of a geographic coordinate system. The acceleration of the imaging device can be identical to an acceleration of the moving object which carries the imaging device. For example, if the imaging device is carried by a UAV, the acceleration of the imaging device can be identical to acceleration of UAV.

The captured images of the environment and the measured attitude information of the imaging device at the timing of capturing the images can be stored together in the memory. The storage of the images and attitude information can be accomplished in a variety of manners. In some instances, the corresponding attitude information can be stored as a portion of the image data. Optionally, the attitude information can be stored in the memory at an address successively after the corresponding image data and before the next image data. Optionally, the corresponding attitude information can be stored in association with the image based on a timing at which the image is captured, such that the attitude information and the image can be inter-linked in the memory. Optionally, the plurality of images can be associated with the corresponding attitude information of the imaging device based on a location at which the plurality of images are captured. The association can be implemented by a GPS information of the imaging device.

In addition to the captured images of the environment and the measured attitude information of the imaging device at the timing of capturing the images, other information can also be associated and stored in the memory. For instance, a timing of imaging, a location, a FOV, a height, a perspective, and/or an imaging parameter (e.g., a shutter speed, ISO, aperture) of the imaging device can be associated and stored in the memory together with captured images and attitude information of the imaging device. The various information can be associated by the timing of capturing the images.

The memory can be a storage device on-board the imaging device. For instance, the memory can be a built-in storage device of the imaging device. The memory may include high-speed random access memory, such as DRAM, SRAM, DDR RAM, or other random access solid state memory devices. Optionally, the memory may include non-volatile memory, such as one or more magnetic disk storage devices, one or more optical disk storage devices, one or more flash memory devices, or one or more other non-volatile solid state storage devices. Alternatively, the memory can be a storage device off-board the imaging device. For instance, the memory can be a storage device remote to the imaging device. The captured images and measured attitude information can be transmitted to the memory via a wired or wireless link. For example, the transmission of images and attitude information can be accomplished by one or more of local area networks (LAN), wide area networks (WAN), infrared, radio, Wi-Fi, point-to-point (P2P) networks, telecommunication networks, cloud communication, and the like. Optionally, relay stations, such as towers, satellites, or mobile stations, can be used.

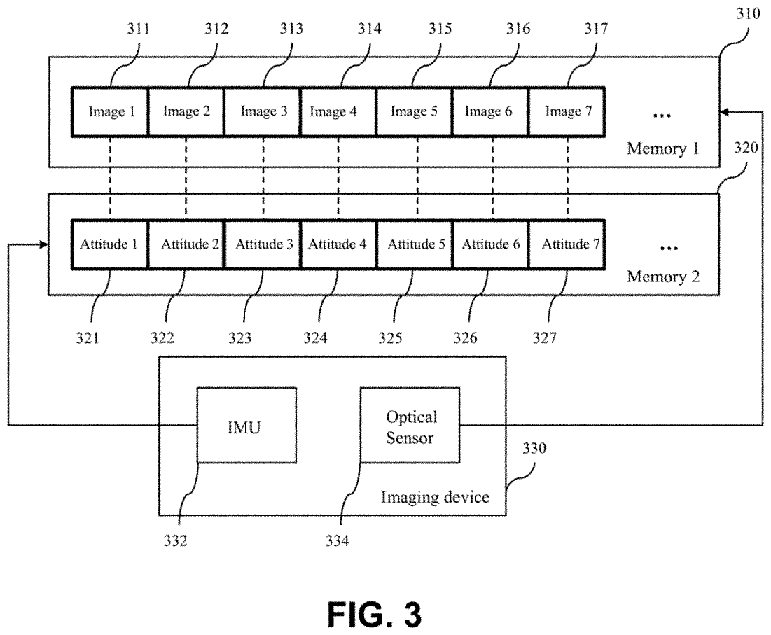

FIG. 3 shows an exemplary configuration of storing images captured by an imaging device and attitude information of the imaging device corresponding to the images, in accordance with another embodiment of the disclosure. The images 311-317 of environment and the corresponding attitude information 221-227 of the imaging device can be stored separately in memories 310 and 320. The images can be captured by the imaging device 330 such as a camera. The camera can be carried by a movable object such as a UAV, and comprise an optical lens (not shown) and an image sensor 334. The imaging device can be provided with an attitude sensor such as an IMU 332, which measures the attitude information of the imaging device at timing of capturing the corresponding image. In some instances, the two memories can be physically separate memory devices. Optionally, the two memories can be different sectors or portions of a same memory device.

The captured images of an environment and the measured attitude information of the imaging device can be separately stored in two memories 310 and 320. The plurality of images can be stored in association with the corresponding attitude information of the imaging device. In some instances, the plurality of images can be associated with the corresponding attitude information of the imaging device based on a timing at which the plurality of images are captured, such that the attitude information and the corresponding image can be linked with each other. Optionally, the plurality of images can be associated with the corresponding attitude information of the imaging device based on a location at which the plurality of images are captured.

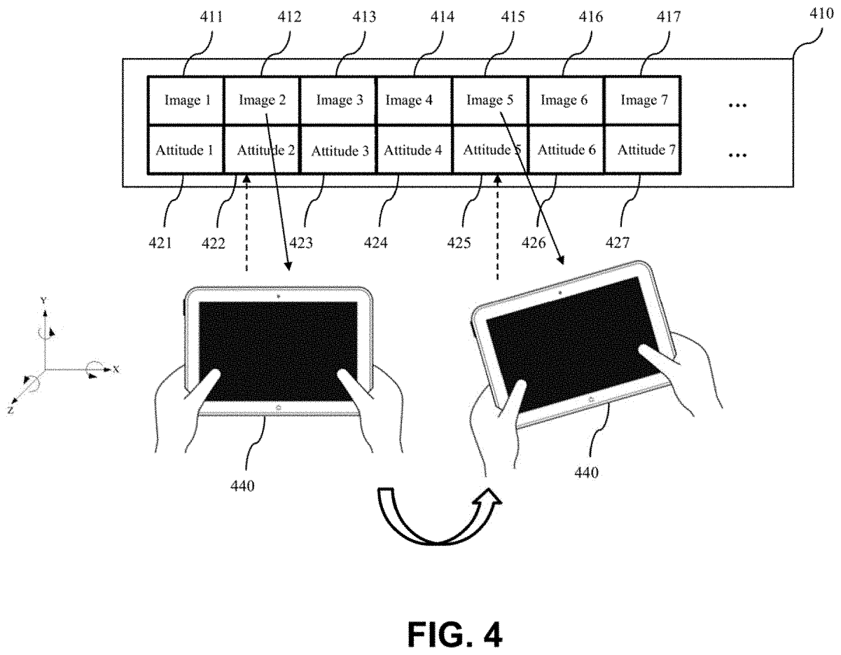

FIG. 4 shows a user holding a displaying terminal and viewing images captured by a imaging device under various orientations, in accordance with an embodiment of the disclosure. The images 411-417 captured by the imaging device and the corresponding attitude information 421-427 of the imaging device, at which the images are captured, are stored in association with each other in a memory 410. The user can hold a displaying terminal 440 and change an attitude thereof while view the images. One or more images can be selected from among the stored images based on the attitude of the displaying terminal. The selected image or images can then be provided to the displaying terminal and displayed. Alternatively, the orientation at which the user wishes to view images can be changed by other types of user input. For instance, the user can change the orientation at which the user wishes to view images by a keyboard, a mouse, a joystick a button, touchpad, trackball, stylus, microphone, motion sensor, or any other type of user interactive device.

The terminal can be a handheld or wearable device. The user can hold the terminal and change the attitude thereof by one hand or by both hands. In some instances, the terminal may be a handheld device configured to be ergonomically held by a single hand or multiple hands. The terminal may have one or more gripping region configured for the user to hold the device. The terminal may be configured to allow a user to view a display while holding and/or tilting the device. The user may comfortably tilt the device about one, two, or three axes while maintaining view of the display. The terminal can include a smartphone, tablet, laptop, computer, glasses, gloves, helmet, microphone, or suitable combinations thereof. The terminal can include a display on which static images or moving images can be displayed. The terminal can include a user interface, such as a keyboard, mouse, joystick, touchscreen, or display. Any suitable user input can be used to interact with the terminal, such as manually entered commands, voice control, gesture control, or position control (e.g., via a movement, location or tilt of the terminal). The displaying terminal can comprise one or more processors (e.g., such as a programmable processor) that are individually or collectively configured to receive a plurality of images captured by the imaging device, and attitude information of the imaging device corresponding to the plurality of images.

The terminal can have one or more sensors that may measure an attitude of the terminal. The attitude of the terminal may be measured relative to a single axis, two axes, or three or more axes. The one or more sensors may be on-board the sensors. The one or more sensors may be within a housing of the terminal. The one or more sensors may measure the attitude of the terminal to any degree of precision or accuracy, such as a precision or accuracy of within 0.01, 0.1, 0.5, 1 2, 3, 5, 7, 10, 15, 20, 25, or 30 degrees.

In the memory, the plurality of images are stored in association with the corresponding attitude information of the imaging device. In some instances, the memory can be remote to the displaying terminal. For instance, the memory can be carried on the UAV or within the imaging device. Optionally, the memory can be provided at a remote server. For instance, the captured images and associated attitude information of the imaging device can be transferred from the imaging device to the remote server and stored therein. The communication between the memory and the displaying terminal (e.g., transmission of attitude of displaying terminal, matching of attitude information, and transmission of selected images) can be accomplished by one or more of local area networks (LAN), wide area networks (WAN), infrared, radio, Wi-Fi, point-to-point (P2P) networks, telecommunication networks, cloud communication, and the like. Optionally, the memory can be local to the displaying terminal. For instance, the captured images and associated attitude information can be copied to a local memory device of the displaying terminal.

An image may be selected from among the plurality of captured images based on an image selection input. The image selection input may be provided via a terminal remote to the image device. The terminal may be a displaying terminal that may display the selected image. The image selection input may comprise inertial information about the displaying terminal. For instance, the inertial information may include an attitude of the displaying terminal, an angular velocity and/or linear velocity of the displaying terminal, and/or an angular acceleration and/or linear acceleration of the displaying terminal. The inertial information may include information about physical disposition and/or movement of the terminal. The inertial information may be provided with respect to a single axis, two axes, or three axes. The inertial information may include whether the terminal is being tilted or shaken.

The image selection input may comprise data from an input device of the terminal. An input device may receive a user input. Examples of an input device may include, but are not limited to, a touchscreen, joystick, trackball, touchpad, stylus, button, key, lever, switch, dial, knob, microphone, motion sensor, heat sensor, or capacitive sensor. The image selection may optionally prioritize inertial information over information from an input device, or vice versa, or allow both types of information to be used in conjunction.

The image may be selected from the plurality of captured images based on an attitude of the displaying terminal and/or the image selection input. For instance, the image selection input can be an attitude of the terminal, as described further herein. In another example, the image selection input can depend on input from an input device, as described further herein.

An image can be selected from among the plurality of captured images based on the attitude of the displaying terminal. For instance, a first image may be captured when the imaging device is at a first orientation, and the first image is selected to be displayed when the displaying terminal is at a second orientation that substantially corresponds to the first orientation. The attitude of the displaying terminal can be measured by an attitude sensor (e.g., an IMU) provided at the displaying terminal. For instance, the displaying terminal (e.g., a tablet) can carry a built-in IMU to measure an attitude thereof.

In some embodiments, the second orientation may correspond to the first orientation when the first and second orientations are identical in three-dimensional space. For instance, the second orientation is considered to correspond to the first orientation when they have an identical pitch angle, a same yaw angle, and/or a same roll angle. Alternatively or additionally, the second orientation may correspond to the first orientation when an acceleration of the displaying terminal with respect to three axes of a reference frame (for example, a yaw-axis, a pitch-axis and a roll-axis of the displaying terminal) is identical to an acceleration of the imaging device with respect to three axes of the surrounding environment (for example, a X-axis, a Y-axis and a Z-axis of a geographic coordinate system). If the displaying terminal is at a three-dimensional attitude which is substantially identical to the attitude 422 of the imaging device at which the image 412 is captured, then the image 412 is selected from among the plurality of captures images which are stored in the memory 410. The selected image can then be provided to the displaying terminal for display. In some instances, the selected image can be a static image of the environment. Optionally, the selected image can be a moving image such as a video. For example, the video can be captured when the UAV carrying the imaging device hovers in the air at an attitude substantially unchanged. For another example, the video can be captured when the UAV carrying the imaging device flies along a straight line at an attitude unchanged. In some embodiments, the second orientation may correspond to the first orientation if a difference between the first and second orientations is within a predetermined range in three-dimensional space. For instance, the second orientation corresponds to the first orientation if a difference in pitch angle, yaw angle and/or roll angle thereof is within 1 degree, 2 degrees, 3 degrees, 4 degrees, 5 degrees, 6 degrees, 7 degrees, 8 degrees, 9 degrees, 10 degrees, 15 degrees, or 20 degrees.

The user can change the attitude of the displaying terminal to view a different image. For example, the user can tilt the displaying terminal along at least one of X axis, Y axis and Z axis as shown in FIG. 4. The X axis, Y axis and Z axis may correspond to a pitch axis, a yaw axis and a roll axis, respectively. As shown in FIG. 4, if the user tilts the displaying terminal to a new attitude which is identical to the attitude 425 of the imaging device at which the image 415 is captured, then the image 415 can be selected from among the plurality of captures images and provided to the displaying terminal for display.

In some embodiments, a substantially identical changing relationship may be provided between an attitude associated with an image and an attitude of the displaying terminal. For instance, a change of five degrees in the attitude of the displaying terminal may result in an image being selected that also has a change in five degrees. This relationship may apply to changes in attitude about all three axes, or may be limited to two axes or one axis. If the relationship does not apply to all axes, other rules, such as those described elsewhere herein may apply to the other axes.

Alternatively, the second orientation may correspond to the first orientation when a pitch angle, a yaw angle and a roll angle of the first orientation are proportional to or otherwise have a functional relation to the corresponding pitch angle, yaw angle, and roll angle of the second orientation. Alternatively or additionally, the second orientation may correspond to the first orientation when an acceleration of the displaying terminal with respect to three axes of a reference frame (for example, a yaw-axis, a pitch-axis and a roll-axis of the displaying terminal) is proportional to or otherwise has a functional relation to an acceleration of the imaging device with respect to three axes of the surrounding environment (for example, a X-axis, a Y-axis and a Z-axis of a geographic coordinate system). The relationship may be a linear relationship. For example, if the displaying terminal is at a three-dimensional attitude (e.g., a pitch angle, a yaw angle and a roll angle) which is 1/K times (K is an integer) the attitude 422 of the imaging device at which the image 412 is captured, then the image 412 is selected from among the plurality of captured images which are stored in the memory 410. If the user tilts the displaying terminal to a new attitude which is 1/K times the attitude 425 (e.g., 1/K times the pitch angle, 1/K times the yaw angle and 1/K times the roll angle) of the imaging device, then the image 415 can be selected and displayed on the displaying terminal. In this manner, the user can view a wide range of images by changing the attitude of displaying terminal within a small range. For instance, if K is 4, then the user can view a wide range of images having a yaw angle range of 360 degrees by simply changing the yaw angle of the displaying terminal within 90 degrees. In some instances, the proportional coefficient or functional relation can be different for the pitch angle, the yaw angle and the roll angle. For instance, if the displaying terminal is at a three-dimensional attitude having a yaw angle 1/K times the yaw angle of the attitude 422, a pitch angle 1/M times the pitch angle of the attitude 422 and a roll angle 1/N times the roll angle of the attitude 422 (K, M and N are different integers), then the corresponding image 412 is selected from among the plurality of captures images.

Alternatively, the second orientation may correspond to the first orientation when any one or two of a pitch angle, a yaw angle and a roll angle of the first orientation being proportional to or otherwise having a functional relation to the corresponding pitch angle, yaw angle, and roll angle of the second orientation. For example, if the yaw angle of the displaying terminal is 1/K times (K is an integer) the yaw angle of the attitude 422 of the imaging device, while the pitch angle and the roll angle of the displaying terminal are respectively identical to the pitch angle and the roll angle of the attitude 422, then the corresponding image 412 is selected from among the plurality of captures images and displayed on the displaying terminal. If the user tilts the displaying terminal to a new attitude at which the yaw angle is 1/K times the yaw angle of the attitude 425 of the imaging device and the pitch angle and the roll angle of the displaying terminal are respectively identical to the pitch angle and the roll angle of the attitude 425, then the corresponding image 415 can be selected and displayed on the displaying terminal. Alternatively or additionally, the second orientation may correspond to the first orientation when any one of an acceleration of the displaying terminal with respect to three axes of a reference frame (for example, a yaw-axis, a pitch-axis and a roll-axis of the displaying terminal) is proportional to or otherwise has a functional relation to a corresponding acceleration of the imaging device with respect to three axes of the surrounding environment (for example, a X-axis, a Y-axis and a Z-axis of a geographic coordinate system).

Alternatively, a similarity between the first orientation and the second orientation can be determined based on a distance therebetween. The first orientation can be denoted by a first vector, and the second orientation can be denoted by a second vector. The second orientation may correspond to the first orientation when a distance between the second orientation and first orientation is below a predetermined threshold. The distance can be Euclidean Distance, Mahalanobis Distance or Cosine Distance. For instance, when the displaying terminal is at a three-dimensional attitude, the image 412 captured at a first attitude 422 can be selected from among the plurality of images if a distance between the second attitude and the first attitude is below a predetermined threshold. In some instances, the image 412 captured by the imaging device at a first attitude 422 can be selected from among the plurality of images if a distance between the second attitude and the first attitude 422 is the smallest one among other first attitudes. The smallest distance between the second attitude and the first attitude can mean that the first attitude 422 is the most similar attitude to the second attitude among the plurality of attitudes 421-427.

A reference frame of the imaging device can correspond to a reference frame of the terminal may align. For instance, the yaw, pitch and roll axes of the imaging device can respectively coincide with the yaw, pitch and roll axes of the terminal, such that an operation (e.g., tilting) of the terminal about a yaw axis results in a change in displayed images about the yaw axis. Alternatively, A reference frame of the imaging device can correspond to a reference frame of the terminal may align. For instance, the yaw, pitch and roll axes of the imaging device may not respectively coincide with the yaw, pitch and roll axes of the terminal. For instance, the yaw axis of the imaging device may correspond to the pitch axis of the terminal, such that a tilting of the terminal about the pitch axis results in a change in displayed images along the yaw axis.

If no image is captured by the imaging device at a first orientation which corresponds to the second attitude of the displaying terminal, then a default image may be displayed on the displaying terminal. In some instances, the default image can be an image captured by the imaging device at attitude of which is in closest proximity to the second orientation. For example, if the displaying terminal is at an attitude not identical to or within a predetermined range of any of the attitude information as stored in the memory, then the image 412 can be selected from among the plurality of images if the attitude of the displaying terminal is in closest proximity to the attitude information 422. The attitude of the displaying terminal in closest proximity to the attitude information 422 can mean the attitude has least change with respect to the attitude information 422. In some instances, the predetermined range may be an angular range considered to be within a close enough proximity to the attitude (e.g., within 10 degrees, 5 degrees, 3 degrees, 2 degrees, 1 degree, 0.5 degrees, 0.1 degrees, 0.01 degrees). Optionally, the default image can be the last displayed image in time sequence. For example, if the user tilts the displaying terminal to an attitude which is not proportional to or otherwise having a functional relation to any of the stored attitude information in the memory, then no new image is displayed, and the displaying terminal continues to display the last displayed image.

In some embodiments, the displaying terminal can be provided with an internal storage device which temporarily stores a plurality of images and associated attitude information of corresponding image. The internal storage device can include high-speed random access memory, such as DRAM, SRAM, DDR RAM, or other random access solid state memory devices. This configuration can allow a fast selection and display of images on the displaying terminal as compared to a configuration where images are directly read from the remote memory in real time. For instance, an initial attitude of the displaying terminal can be sent to the remote memory via for example a wireless link, and a plurality of images can be read from the memory and temporarily stored in the internal storage device of the displaying terminal. The plurality of images can include one or more images which are associated with attitude information substantially corresponding to the initial attitude information of the displaying terminal, a number of images captured before the one or more images and a number of images captured after the one or more images. The associated attitude information of the plurality of images can also be read from the memory and temporarily stored in the internal storage device of the displaying terminal.

If the user changes an attitude of the displaying terminal, a new image to be displayed can be first searched in the internal storage device. If no image having associated attitude information corresponding to the new attitude of the terminal is found in the internal storage device, a search can then be performed in the memory onboard the imaging device for images having associated attitude information corresponding to the changed attitude of the displaying terminal. A new set of images, including the image having associated attitude information substantially corresponding to the new attitude information of the displaying terminal, a number of images captured before that image and a number of images captured after that image, can be read from the memory onboard the imaging device and temporarily stored in the internal storage device of the displaying terminal based on the new attitude of the displaying terminal. The reading and storing of new set of images in the internal storage device can be a dynamic process. In other words, the internal storage device of the displaying terminal can be updated in real time based on a change in attitude of the displaying terminal, such that the image having associated attitude information substantially corresponding to the attitude information of the displaying terminal is stored in the internal storage device.

Alternatively, the high-speed internal storage device can be provided at the imaging device. In case the imaging device is carried by a movable object such as a UAV, the high-speed internal storage device can be provided at the movable object. In some instances, the initial attitude information of the displaying terminal can be sent to the imaging device via for example a wireless link, and a plurality of images can be read from the memory of the imaging device and temporarily stored in the internal storage device of the imaging device. The plurality of images can include one or more images which are associated with attitude information substantially corresponding to the initial attitude information of the displaying terminal, a number of images captured before the one or more images and a number of images captured after the one or more images. The associated attitude information of the images can also be read from the memory and temporarily stored in the internal storage device of the imaging device. The one or more images to be displayed can be first searched in the high-speed internal storage device. For example, if the user changes an attitude of the displaying terminal by for example, tilting the terminal about at least one of yaw axis, pitch axis and roll axis, a new image to be displayed can be first searched in the high-speed internal storage device. If no image having associated attitude information corresponding to the new attitude of the terminal is found in the internal storage device, a new set of images can be retrieved from the memory based on the new attitude of the displaying terminal, the new set of images including the image(s) having associated attitude information substantially corresponding to the new attitude information of the displaying terminal, a number of images captured before that image(s) and a number of images captured after that image(s). The internal storage device can be updated with the new set of images. The reading and storing of new set of images can be a dynamic process. In other words, the internal storage device of the imaging device can be updated in real time based on a change in attitude of the displaying terminal, such that the image(s) having associated attitude information substantially corresponding to the attitude information of the displaying terminal is can be first searched in the internal storage device with a higher speed.

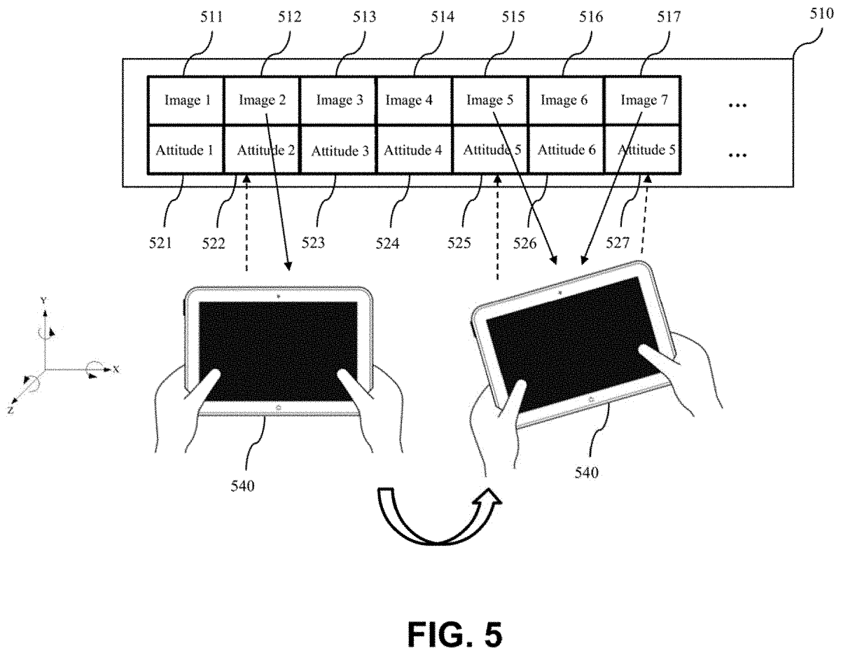

FIG. 5 shows a user holding a displaying terminal and viewing images captured by a camera under various orientations, in accordance with another embodiment of the disclosure. The images 511-517 captured by the imaging device and the corresponding attitude information 521-527 of the imaging device, at which the images are captured, are stored in association with each other in a memory 510. The user can hold a displaying terminal 540 and change an attitude thereof (e.g., by tilting the displaying terminal). One or more images can be selected from among the stored images based on the attitude of the displaying terminal. The selected image or images can then be displayed on the displaying terminal.

More than one image can be selected from among the plurality of captured images based on the attitude of the displaying terminal. For instance, a first plurality of images may be captured when the imaging device is at a first orientation, and the first plurality of images can be selected to be displayed on the displaying terminal when the displaying terminal is at a second orientation that substantially corresponds to the first orientation. In some embodiments, the second orientation may correspond to the first orientation when the first and second orientations have a same pitch angle, a same yaw angle, and/or a same roll angle. Alternatively, the second orientation may correspond to the first orientation when the pitch angle, yaw angle, and/or roll angle of the first orientation being proportional to or otherwise having a functional relation to the pitch angle, yaw angle, and/or roll angle of the second orientation. Alternatively, a distance between the second attitude and the first attitude can be below a predetermined threshold. For instance, a distance between the second attitude and the first attitude can be the smallest one.

The first plurality of images can be displayed on the displaying terminal under various rules. In some instances, the first plurality of images can be consecutively displayed on the displaying terminal in a sequence of a time of being captured. For example, two images 515 and 517 are captured when the imaging device is at a first orientation 525. When the displaying terminal is at a second orientation which corresponds to the first orientation 525, the two images 515 and 517 can be displayed on the displaying terminal in a sequence of a timing being captured. Optionally, only one image from among the first plurality of images, which has least change in orientation as compared to the last displayed image, can be displayed on the displaying terminal. Optionally, only one image from among the first plurality of images, which has least change in spatial location as compared to the last displayed image, can be displayed on the displaying terminal. The spatial location may refer to the perspective/waypoint from which the image is captured. Optionally, only one image from among the first plurality of images, which has least change in the image content as compared to the last displayed image, can be displayed on the displaying terminal. Optionally, only one image from among the first plurality of images, which has least change in the image parameter (e.g., a shutter speed, ISO, aperture) as compared to the last displayed image, can be displayed on the displaying terminal. The displayed image can be a static image or a moving image.

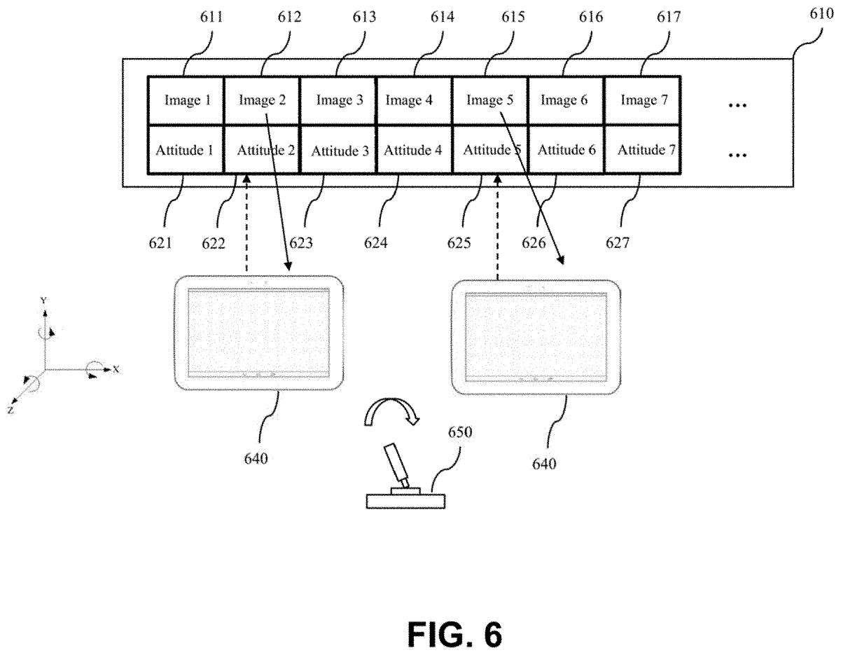

FIG. 6 shows a user manipulating an input device and viewing images captured by a camera under various orientations on a displaying terminal, in accordance with an embodiment of the disclosure. The images 611-617 captured by the imaging device and the corresponding attitude information 621-627 of the imaging device, at which the images are captured, are stored in association with each other in a memory 610. Alternatively or additionally, the user can manipulate an input device 650 to change an orientation at which the user wishes to view images of the captured object, such that the images as captured by the imaging device can be selected and displayed based on the corresponding attitude information of the imaging device. The input device can include a joystick, a track ball, a touchscreen, a touch pad, a mouse, or any other user interactive described elsewhere herein.

Alternatively or additionally, the user can input the desired viewing orientation by interacting with the screen of the displaying terminal. The screen of the displaying terminal can be a touch panel which is capable of receiving user's simple or multi-touch gestures by touching the screen with a special stylus and/or one or more fingers. For instance, the user can touch and/or drag on the screen of the displaying terminal to change the desired viewing orientation. The user's screen operation can be converted into the desired viewing orientation, and one or more images can be selected from among the stored images based on the attitude information of the imaging device at which the image of environment is captured. The selected image or images can then be provided to the displaying terminal for display.

For instance, a first image may be captured when the imaging device is at a first orientation, and the first image can be selected to be displayed when the joystick creates a second orientation that substantially corresponds to the first orientation. The user can manipulate the joystick so as to view a different image. For example, the user can manipulate the joystick along at least one of X axis, Y axis and Z axis as shown in FIG. 6. The X axis, Y axis and Z axis may correspond to a pitch axis, a yaw axis and a roll axis, respectively. If the user manipulate the joystick to create a new attitude that substantially corresponds to the attitude 625 of the imaging device at which the image 615 is captured, then the image 615 can be selected from among the plurality of captures images and displayed on the displaying terminal. For another instance, the user can input or change the desired viewing orientation by touching and dragging/sliding on a touch screen of the displaying terminal. The user's operation on screen of terminal can be converted into the desired viewing orientation by for example extracting a velocity of user's dragging along three axes and integrating the velocity with duration of dragging/sliding. One or more images can be selected from among the stored images based on the desired viewing orientation, as discussed hereinabove.

More than one image can be selected from among the plurality of captured images based on the attitude of the displaying terminal. The more than one image can be displayed on the displaying terminal under various predetermined rules, as discussed herein above. For instance, the image having least change in a sequence of a timing being captured, or least change in orientation as compared to the last displayed image, or least change in spatial location as compared to the last displayed image, or least change in the image content as compared to the last displayed image and/or least change in the image parameter (e.g., a shutter speed, ISO, aperture) as compared to the last displayed image, can be displayed. If no image is captured by the imaging device at a first orientation which corresponds to the second attitude of the displaying terminal, a default image may be displayed on the displaying terminal, as discussed herein above. The selected image to be displayed can be a static image or a moving image.

The joystick can be used in combination with user's manipulating on the displaying terminal. For instance, in case a plurality of images having various FOVs are captured by the imaging device at a first orientation (e.g., the plurality of images can be captured by a spherical camera), the user can manually change an attitude of the displaying terminal (e.g., by tilting the terminal) to a second attitude which substantially correspond to the first orientation, and then input the desired viewing orientation by operating the joystick, such that the user can view various images captured at the first orientation. In this scenario, a virtual reality experience is provided as if the user stops at a certain position and views images of the environment at various viewing orientation. The user can similarly input the desired viewing orientation by interacting with the screen of the displaying terminal (e.g., by touching and/or dragging on the screen of the displaying terminal to change the desired viewing orientation).

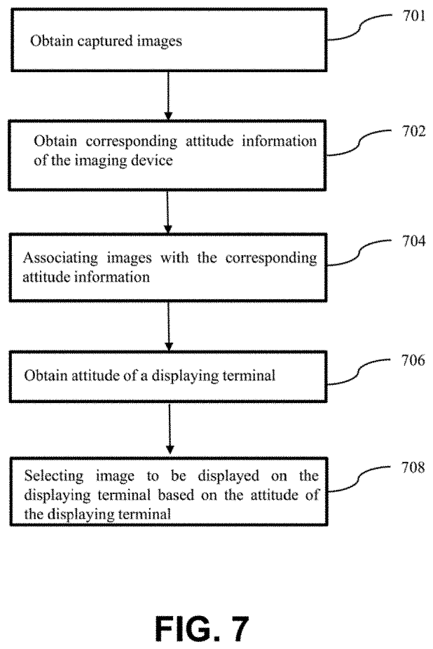

FIG. 7 is a flow chart illustrating a method of processing images of an environment based on attitude of displaying terminal, in accordance with an embodiment of the disclosure. The method can be performed to associate images captured by imaging device with attitude information of the imaging device corresponding to the images. The method of processing images of an environment can be performed at the imaging device or a remote server. The association of images and attitude information can enable a user to view images of an environment at various orientations, and provide the user an experience of virtual reality. The method of processing image data of an environment can be performed by one or more processors, such as a programmable processor (e.g., a central processing unit (CPU)). The method of processing image data of an environment can be provided in a form of non-transitory computer readable medium. For instance, the non-transitory computer readable medium can comprise machine executable code that, upon execution by one or more computer processors, implements the method for processing image data of an environment. In the method of processing images of an environment, a plurality of images captured using an imaging device, and attitude information of the imaging device corresponding to the plurality of images can be obtained. The plurality of images with the corresponding attitude information of the imaging device can be associated. One or more images to be displayed on a terminal can be selected, from among the plurality of images, based on attitude information of the terminal and the attitude information of the imaging device corresponding to the plurality of images.

In process 701, a plurality of images captured by an imaging device can be obtained. In process 702, attitude information of the imaging device corresponding to the plurality of images can be obtained. The process of obtaining the plurality of images and the process of obtaining attitude information of the imaging device can be performed concurrently or sequentially. The imaging device can be a camera carried by a movable object such as a UAV. In some instances, the UAV can perform a scheduled or autonomous or manually controlled flight within an environment, and capture a plurality of images of the environment at different orientations. The corresponding attitude information of the imaging device can be measured by an attitude sensor (e.g., an IMU) while the imaging device capturing the images.

In process 704, the plurality of images can be associated with the corresponding attitude information of the imaging device. In some instances, the corresponding attitude information of the imaging device can be associated with the image based on a timing at which the image is captured by the imaging device. Optionally, the corresponding attitude information of the imaging device can be associated with the image based on a position at which the image is captured by the imaging device. The association of the corresponding attitude information of the imaging device with the images can be performed by one or more processors on-board or off-board the movable object.

The method of processing images of an environment can further comprise processes 706 and 708. In process 706, attitude information of the terminal can be obtained, for example, by receiving the attitude information of the terminal via a wireless link. The displaying terminal can be remote to the imaging device. The terminal can include a smartphone, tablet, laptop, computer, glasses, gloves, helmet, microphone, or suitable combinations thereof. The terminal can include a display on which static images or moving images can be displayed. The attitude of the displaying terminal can be measured by a built-in attitude sensor (e.g., an IMU) of the displaying terminal.

In process 708, one or more images to be displayed on a displaying terminal can be selected from among the plurality of images based on attitude information of the terminal. A first image may be captured when the imaging device is at a first orientation, and the first image is selected to be displayed on the displaying terminal when the displaying terminal is at a second orientation that substantially corresponds to the first orientation. In some instances, the second orientation may correspond to the first orientation when the first and second orientations have a same pitch angle, a same yaw angle, and/or a same roll angle. Optionally, the second orientation may correspond to the first orientation when the pitch angle, yaw angle, and/or roll angle of the first orientation being proportional to or otherwise having a functional relation to the pitch angle, yaw angle, and/or roll angle of the second orientation. Optionally, the second orientation may correspond to the first orientation when a distance between the first and second orientations is below a predetermined threshold. In some embodiments, the method can further comprise transmitting the selected images to the displaying terminal via a wireless link.

If more than one image is captured by the imaging device at a first orientation which corresponds to the second attitude of the displaying terminal, the images can be consecutively displayed on the displaying terminal in a sequence of a time of being captured. Optionally, only one image from among the images, which has least change in the image content as compared to the last displayed image, can be displayed on the displaying terminal.

If no image is captured by the imaging device at a first orientation which corresponds to the second attitude of the displaying terminal, a default image may be displayed on the displaying terminal. The default image can be an image captured by the imaging device at attitude of which is in closest proximity to the second orientation. Optionally, the default image can be the last displayed image.

In some embodiments, the one or more images to be displayed on the displaying terminal can be directly read from the memory onboard the imaging device in real time. For instance, the attitude information of the displaying terminal can be received by the imaging device via a wireless link, and the one or more images can be selected from among the plurality of images which are stored in the memory onboard the imaging device based on the received attitude information of the terminal.

Alternatively, the imaging device can be provided with an internal storage device to temporarily store a plurality of images and associated attitude information of corresponding image. For instance, the attitude information of the displaying terminal can be received by the imaging device via a wireless link, and a plurality of images can be read from the memory onboard the imaging device and temporarily stored in the internal storage device. The plurality of images can include one or more images which are associated with attitude information substantially corresponding to the attitude information of the displaying terminal, a number of images captured before the one or more images and a number of images captured after the one or more images. The associated attitude information of the plurality of images can also be read from the memory and temporarily stored in the internal storage device of the imaging device. The set of images in the internal storage device can be updated in real time based on the received updated attitude of the displaying terminal, such that the image having associated attitude information substantially corresponding to the attitude of the displaying terminal is stored in the internal storage device. With this configuration, the method of processing images of an environment can further comprise a process, for example after process 706, of temporarily storing in an internal storage device of the imaging device a plurality of images, the plurality of images comprising one or more images having associated attitude information corresponding to the attitude information of the terminal. With this configuration, in the process 708 of selecting image(s) to be displayed can be first performed in the internal storage device. If no image having associated attitude information corresponding to the updated attitude of the terminal is found in the internal storage device, a search can be performed in the memory. A new set of images, including the image having associated attitude information substantially corresponding to the updated attitude information of the displaying terminal, can be read from the memory and temporarily stored in the internal storage device based on the updated attitude of the displaying terminal.

Still alternatively, the high-speed internal storage device can be provided at the displaying terminal to temporarily store a plurality of images and associated attitude information of corresponding image. For instance, a plurality of images can be read from the memory onboard the imaging device and temporarily stored in the internal storage device of the imaging device. The set of images in the internal storage device can be updated in real time based on the received updated attitude of the displaying terminal.

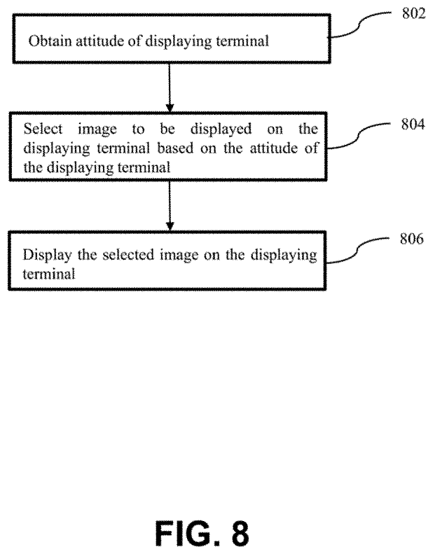

FIG. 8 is a flow chart illustrating a method of displaying image data of an environment on a displaying terminal based on attitude of the terminal, in accordance with an embodiment of the disclosure. The method can be performed at a displaying terminal to view images of an environment at various orientations. The method can be performed by one or more processors, and provided in a form of non-transitory computer readable medium. The one or more processors can be provided within the displaying terminal. In the method of displaying image data of an environment on a terminal, an attitude of the terminal can be obtained, and one or more images to be displayed on the terminal can be selected from among a plurality of images based on the attitude of the terminal, the plurality of images being associated with the corresponding attitude information of the imaging device. The selected one or more images can be displayed on the terminal. In some embodiments, the one or more images to be displayed can be retrieved at the memory or a high-speed storage device which is for example onboard the imaging device. Alternatively, the one or more images to be displayed can be retrieved at a local storage device onboard the displaying terminal, the local storage device can receive and temporarily store a plurality of images from the imaging device, as discussed hereinabove.

In process 802, attitude information of the displaying terminal can be obtained. The attitude of the displaying terminal can be measured by a built-in attitude sensor (e.g., an IMU) of the displaying terminal. The terminal can be remote to the imaging device which captures images of environment. The terminal can include a smartphone, tablet, laptop, computer, glasses, gloves, helmet, microphone, or suitable combinations thereof.

In process 804, one or more images to be displayed on the displaying terminal can be searched and selected from among a plurality of captured images based on attitude information of the terminal. A first image may be captured when the imaging device is at a first orientation, and the first image is selected to be displayed on the displaying terminal when the displaying terminal is at a second orientation that substantially corresponds to the first orientation. The second orientation may correspond to the first orientation when the first and second orientations have a same pitch angle, a same yaw angle, and/or a same roll angle, when the pitch angle, yaw angle, and/or roll angle of the first orientation being proportional to or otherwise having a functional relation to the pitch angle, yaw angle, and/or roll angle of the second orientation, or when a distance between the second attitude and the first attitude being below a predetermined threshold. If more than one image is captured by the imaging device at a first orientation which substantially corresponds to the second attitude of the displaying terminal, the images can be consecutively displayed on the displaying terminal in a sequence of a time of being captured. Optionally, only one image from among the images, which has least change in the image content as compared to the last displayed image, can be displayed on the displaying terminal. If no image is captured by the imaging device at a first orientation which corresponds to the second attitude of the displaying terminal, a default image may be displayed on the displaying terminal. The default image can be an image captured by the imaging device at attitude of which is in closest proximity to the second orientation. Optionally, the default image can be the last displayed image.

In some embodiments, the imaging device can be provided with a high-speed internal storage device which temporarily stores a plurality of images and associated attitude information of corresponding image. In case the imaging device is carried by a movable object such as a UAV, the high-speed internal storage device can be provided at the movable object. A plurality of images can be read from the memory of the imaging device and temporarily stored in the internal storage device of the imaging device based on the attitude information of the displaying terminal. For instance, the plurality of images can include one or more images which are associated with attitude information substantially corresponding to the initial attitude information of the displaying terminal, a number of images captured before the one or more images and a number of images captured after the one or more images. The one or more images to be displayed can be first searched in the high-speed internal storage device, as discussed hereinabove.

Alternatively, the high-speed an internal storage device can be provided at the displaying terminal. With this configuration, the method of displaying image data of an environment can further comprise a process, for example before process 804, of receiving from the imaging device and temporarily storing in the internal storage device a plurality of images, the plurality of images can include one or more images which are associated with attitude information substantially corresponding to the attitude information of the displaying terminal. The image to be displayed can first be searched in the internal storage device of the displaying terminal. If no image having associated attitude information corresponding to the new attitude of the terminal is found in the internal storage device, a search can then be performed in the memory onboard the imaging device for images having associated attitude information corresponding to the changed attitude of the displaying terminal. A new set of images, including the image having associated attitude information substantially corresponding to the attitude information of the displaying terminal, can be read from the memory onboard the imaging device and temporarily stored in the internal storage device of the displaying terminal based on the attitude of the displaying terminal. The reading and storing of new set of images in the internal storage device can be a dynamic process, as discussed above.

In process 806, the selected one or more images can be displayed on the displaying terminal. If more than one image is captured by the imaging device at a first orientation which corresponds to the second attitude of the displaying terminal, the images can be displayed under various rules, as discussed hereinabove.

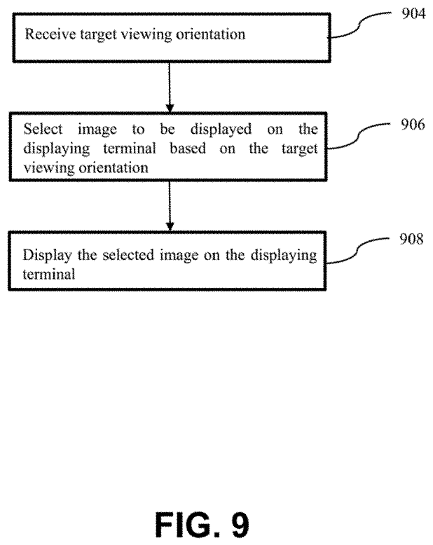

FIG. 9 is a flow chart illustrating a method of processing images of an environment based on attitude of imaging device and/or user's target viewing orientation, in accordance with an embodiment of the disclosure. The method can be performed to view images of an environment at different orientation by allowing target viewing orientation input from user. For instance, the user can input a target viewing orientation at which the user wishes to view images of the captured object, such that the images as captured by the imaging device can be selected and displayed based on the corresponding attitude information of the imaging device and the target viewing orientation. The input device can include a joystick, a track ball, a touch pad or a mouse. Alternatively or additionally, the user can input the target orientation of viewing images by operating a screen operation on a screen of the displaying terminal. In the method of displaying image data of an environment on a terminal, a target viewing orientation can be input, and one or more images to be displayed on the terminal can be selected from among a plurality of images based on the input target viewing orientation, the plurality of images being associated with the corresponding attitude information of the imaging device. The selected one or more images can be displayed on the terminal. In some embodiments, the one or more images to be displayed can be retrieved at the memory or a high-speed storage device which is for example onboard the imaging device. Alternatively, the one or more images to be displayed can be retrieved at a local storage device onboard the displaying terminal, the local storage device can receive and temporarily store a plurality of images from the imaging device, as discussed hereinabove. The method can be advantageous if the displaying terminal is not a handheld terminal. For instance, the user can view images of an environment at different orientation from a laptop by using a mouse or a keyboard to input the target viewing orientation.

In process 902, a target viewing orientation can be received. The target viewing orientation can be a desired viewing orientation at which the user wishes to view the images of the environment. The user can input the target viewing orientation through for example a joystick, a track ball, a touch pad or a mouse. Alternatively or additionally, the user can input the target viewing orientation by operating on a screen of the displaying terminal. For instance, the user can input and change the target viewing orientation by tapping and dragging on the screen of a tablet.

In process 904, one or more images to be displayed on the displaying terminal can be selected from among a plurality of captured images based on attitude information of the terminal. A first image may be captured when the imaging device is at a first orientation, and the first image is selected to be displayed on the displaying terminal when the displaying terminal is at a second orientation that substantially corresponds to the first orientation. The second orientation may correspond to the first orientation when the first and second orientations have a same pitch angle, a same yaw angle, and/or a same roll angle, when the pitch angle, yaw angle, and/or roll angle of the first orientation being proportional to or otherwise having a functional relation to the pitch angle, yaw angle, and/or roll angle of the second orientation, or when a distance between the second attitude and the first attitude being below a predetermined threshold. If more than one image is captured by the imaging device at a first orientation which corresponds to the second attitude of the displaying terminal, the images can be consecutively displayed on the displaying terminal in a sequence of a time of being captured. Optionally, only one image from among the images, which has least change in the image content as compared to the last displayed image, can be displayed on the displaying terminal. If no image is captured by the imaging device at a first orientation which corresponds to the second attitude of the displaying terminal, a default image may be displayed on the displaying terminal. The default image can be an image captured by the imaging device at attitude of which is in closest proximity to the second orientation. Optionally, the default image can be the last displayed image.

In some embodiments, the imaging device can be provided with a high-speed internal storage device which temporarily stores a plurality of images and associated attitude information of corresponding image. A plurality of images can be read from the memory of the imaging device and temporarily stored in the internal storage device of the imaging device based on the attitude information of the displaying terminal. The one or more images to be displayed can be first searched in the high-speed internal storage device. Alternatively, the high-speed an internal storage device can be provided at the displaying terminal. With this configuration, the method of displaying image data of an environment can further comprise a process, for example before process 904, of receiving from the imaging device and temporarily storing in the internal storage device a plurality of images, the plurality of images can include one or more images which are associated with attitude information substantially corresponding to the attitude information of the displaying terminal. The image to be displayed can first be searched in the internal storage device of the displaying terminal, as discussed above.

In process 906, the selected one or more images can be displayed on the displaying terminal. If more than one image is captured by the imaging device at a first orientation which corresponds to the second attitude of the displaying terminal, the images can be displayed under various rules, as discussed hereinabove.

As previously described, a user may interact with a terminal to provide an image selection input (e.g., inertial information of terminal, information from an input device of the terminal). An image may be selected from a plurality of available images based on the image selection input. The image may be selected based on an attitude of the image in response to the image selection input. A user may manipulate the terminal to view the collected images. The user may be manipulating the terminal to control the direction of the direction of view of the images. This may enable the user to enjoy a virtual reality experience of an environment using images that were already collected within the environment through an intuitive manipulation of the terminal. The virtual reality experience may allow a user to view actual images of the environment and gain a realistic view of different directions within the environment. The virtual reality experience may also allow the user to have a realistic view from different perspectives within the environment. The use of a UAV may allow the user to access points of view that may not be available from the ground. The user may enjoy this virtual reality experience after the UAV has completed its flight to collect images. Alternatively, the user may enjoy this virtual reality experience while the UAV is in flight collecting images.

The systems, devices, and methods described herein can be applied to a wide variety of objects, including movable objects and stationary objects. The movable object may be capable of moving freely within the environment with respect to six degrees of freedom (e.g., three degrees of freedom in translation and three degrees of freedom in rotation). Alternatively, the movement of the movable object can be constrained with respect to one or more degrees of freedom, such as by a predetermined path, track, or orientation. The movement can be actuated by any suitable actuation mechanism, such as an engine or a motor. The actuation mechanism of the movable object can be powered by any suitable energy source, such as electrical energy, magnetic energy, solar energy, wind energy, gravitational energy, chemical energy, nuclear energy, or any suitable combination thereof. The movable object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof. Alternatively, the movable object may be carried by a living being.

The movable object can be controlled remotely by a user or controlled locally by an occupant within or on the movable object. The movable object may be controlled remotely via an occupant within a separate vehicle. In some embodiments, the movable object is an unmanned movable object, such as a UAV. An unmanned movable object, such as a UAV, may not have an occupant onboard the movable object. The movable object can be controlled by a human or an autonomous control system (e.g., a computer control system), or any suitable combination thereof. The movable object can be an autonomous or semi-autonomous robot, such as a robot configured with an artificial intelligence.

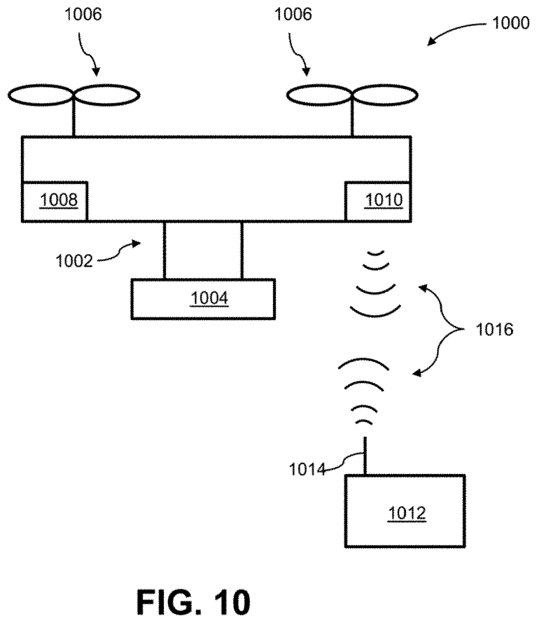

FIG. 10 illustrates a movable object 1000 including a carrier 1002 and a payload 1004, in accordance with embodiments of the present disclosure. Although the movable object 1000 is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., an UAV). In some instances, the payload 1004 may be provided on the movable object 1000 without requiring the carrier 1002. The movable object 1000 may include propulsion mechanisms 1006, a sensing system 1008, and a communication system 1010. The payload 1004 can be an imaging device such as a camera. The distance between shafts of opposite rotors can be any suitable length. For example, the length can be less than or equal to 2 m, or less than equal to 5 m. In some embodiments, the length can be within a range from 40 cm to 1 m, from 10 cm to 2 m, or from 5 cm to 5 m.

The propulsion mechanisms 1006 can include one or more of rotors, propellers, blades, engines, motors, wheels, axles, magnets, or nozzles, as previously described. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 1006 can be mounted on the movable object 1000 using any suitable means, such as a support element (e.g., a drive shaft) as described elsewhere herein. The propulsion mechanisms 1006 can be mounted on any suitable portion of the movable object 1000, such on the top, bottom, front, back, sides, or suitable combinations thereof.

In some embodiments, the propulsion mechanisms 1006 can enable the movable object 1000 to take off vertically from a surface or land vertically on a surface without requiring any horizontal movement of the movable object 1000 (e.g., without traveling down a runway). Optionally, the propulsion mechanisms 1006 can be operable to permit the movable object 1000 to hover in the air at a specified position and/or orientation. One or more of the propulsion mechanisms 1000 may be controlled independently of the other propulsion mechanisms. Alternatively, the propulsion mechanisms 1000 can be configured to be controlled simultaneously. For example, the movable object 1000 can have multiple horizontally oriented rotors that can provide lift and/or thrust to the movable object. The multiple horizontally oriented rotors can be actuated to provide vertical takeoff, vertical landing, and hovering capabilities to the movable object 1000. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 1000 (e.g., with respect to up to three degrees of translation and up to three degrees of rotation).

The sensing system 1008 can include one or more sensors that may sense the spatial disposition, velocity, and/or acceleration of the movable object 1000 (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system 1008 can be used to control the spatial disposition, velocity, and/or orientation of the movable object 1000 (e.g., using a suitable processing unit and/or control module, as described below). Alternatively, the sensing system 1008 can be used to provide data regarding the environment surrounding the movable object, such as weather conditions, proximity to potential obstacles, location of geographical features, location of manmade structures, and the like.

The communication system 1010 enables communication with terminal 1012 having a communication system 1014 via wireless signals 1016. The communication systems 1010, 1014 may include any number of transmitters, receivers, and/or transceivers suitable for wireless communication. The communication may be one-way communication, such that data can be transmitted in only one direction. For example, one-way communication may involve only the movable object 1000 transmitting data to the terminal 1012, or vice-versa. The data may be transmitted from one or more transmitters of the communication system 1010 to one or more receivers of the communication system 1012, or vice-versa. Alternatively, the communication may be two-way communication, such that data can be transmitted in both directions between the movable object 1000 and the terminal 1012. The two-way communication can involve transmitting data from one or more transmitters of the communication system 1010 to one or more receivers of the communication system 1014, and vice-versa.

In some embodiments, the terminal 1012 can provide control data to one or more of the movable object 1000, carrier 1002, and payload 1004 and receive information from one or more of the movable object 1000, carrier 1002, and payload 1004 (e.g., position and/or motion information of the movable object, carrier or payload; data sensed by the payload such as image data captured by a payload camera). In some instances, control data from the terminal may include instructions for relative positions, movements, actuations, or controls of the movable object, carrier and/or payload. For example, the control data may result in a modification of the location and/or orientation of the movable object (e.g., via control of the propulsion mechanisms 1006), or a movement of the payload with respect to the movable object (e.g., via control of the carrier 1002). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 1008 or of the payload 1004). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier and/or payload. Such information from a payload may include data captured by the payload or a sensed state of the payload. The control data provided transmitted by the terminal 1012 can be configured to control a state of one or more of the movable object 1000, carrier 1002, or payload 1004. Alternatively or in combination, the carrier 1002 and payload 1004 can also each include a communication module configured to communicate with terminal 1012, such that the terminal can communicate with and control each of the movable object 1000, carrier 1002, and payload 1004 independently.

In some embodiments, the movable object 1000 can be configured to communicate with another remote device in addition to the terminal 1012, or instead of the terminal 1012. The terminal 1012 may also be configured to communicate with another remote device as well as the movable object 1000. For example, the movable object 1000 and/or terminal 1012 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 1000, receive data from the movable object 1000, transmit data to the terminal 1012, and/or receive data from the terminal 1012. Optionally, the remote device can be connected to the Internet or other telecommunications network, such that data received from the movable object 1000 and/or terminal 1012 can be uploaded to a website or server.

While some embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

What is claimed is:

1. A method for processing image data of an environment, the method comprising:
obtaining (1) a plurality of images captured using an imaging device, and (2) attitude information of the imaging device corresponding to the plurality of images; and
associating the plurality of images with the corresponding attitude information of the imaging device.

2. The method of claim 1, wherein the plurality of images are associated with the corresponding attitude information of the imaging device based on at least one of a timing at which the plurality of images are captured or a spatial position at which the plurality of images are captured.

3. The method of claim 1, wherein the images are stored in association with the attitude information of the imaging device.

4. The method of claim 1, wherein the images and the attitude information of the imaging device are separately stored.

5. The method of claim 1, further comprising selecting, from among the plurality of images, one or more images to be displayed on a terminal remote from the imaging device, wherein the one or more images are selected based on attitude information of the terminal.

6. The method of claim 5, wherein the attitude information of the imaging device includes a pitch angle, a yaw angle, and/or a roll angle of the imaging device.

7. The method of claim 6, wherein an image among the plurality of images is captured when the imaging device is at a first orientation, and is selected to be displayed on the terminal when the terminal is at a second orientation that substantially corresponds to the first orientation, wherein the first orientation includes a pitch angle, a yaw angle, and a roll angle, the second orientation includes a pitch angle, a yaw angle, and a roll angle.

8. The method of claim 7, wherein:
the first and second orientations have substantially same pitch angle, yaw angle, and/or roll angle;
the pitch angle, yaw angle, and/or roll angle of the first orientation is proportional to the pitch angle, yaw angle, and/or roll angle of the second orientation;
the pitch angle, yaw angle, and/or roll angle of the first orientation has a functional relation to the pitch angle, yaw angle, and/or roll angle of the second orientation; or
the first orientation is denoted by a first vector and the second orientation is denoted by a second vector, a distance between the first vector and the second vector is less than or equal to a predetermined threshold.

9. The method of claim 6, wherein a default image is selected for displaying on the terminal, if no image is captured by the imaging device at a first orientation substantially corresponding to a second orientation of the terminal, when the terminal is at the second orientation.

10. The method of claim 9, wherein the default image is:
an image having associated attitude information which has least change with respect to the second orientation, or
the last displayed image.

11. The method of claim 6, wherein a first plurality of images among the plurality of images are captured when the imaging device is at a first orientation, and wherein the first plurality of images are selected to be displayed on the terminal when the terminal is at a second orientation that substantially corresponds to the first orientation, wherein the first orientation includes a pitch angle, a yaw angle, and a roll angle, the second orientation includes a pitch angle, a yaw angle, and a roll angle.

12. The method of claim 11, wherein:
the first and second orientations have substantially same pitch angle, yaw angle, and/or roll angle;
the pitch angle, yaw angle, and/or roll angle of the first orientation is proportional to the pitch angle, yaw angle, and/or roll angle of the second orientation; or
the pitch angle, yaw angle, and/or roll angle of the first orientation has a functional relation to the pitch angle, yaw angle, and/or roll angle of the second orientation.

13. The method of claim 11, wherein:
the first plurality of images are consecutively displayed on the terminal in a sequence of time of being captured; or
one image among the first plurality of images is displayed on the terminal, the image has least change in image content, least change in spatial location, or least change in orientation as compared to the image last displayed.

14. The method of claim 5, wherein the attitude information of the imaging device includes an acceleration of the imaging device.

15. The method of claim 1, wherein the attitude information of the imaging device is obtained using one or more inertial sensors operably coupled to the imaging device.

16. The method of claim 1, wherein the plurality of images include moving images.

17. The method of claim 1, wherein the imaging device is operably coupled to a movable object.

18. The method of claim 17, wherein the movable object is an Unmanned Aerial Vehicle (UAV) and the attitude information of the imaging device includes attitude information of the UAV.

19. An apparatus for processing image data of an environment, the apparatus comprising one or more processors that are individually or collectively configured to:
obtain (1) a plurality of images captured using an imaging device and (2) attitude information of the imaging device corresponding to the plurality of images; and
associate the plurality of images with the corresponding attitude information of the imaging.

20. A movable object, comprising:
one or more propulsion units that effect a movement of the movable object; and
a system for processing image data of an environment including:
an imaging device configured to capture a plurality of images;
an inertial sensor configured to collect attitude information of the imaging device corresponding to the plurality of images; and
one or more processors that are individually or collectively configured to associate the plurality of images with the corresponding attitude information of the imaging device.
